(19) United States
(12) Patent Application Publication
(10) Pub. No.: US 2023/0087568 A1
(43) Pub. Date: Mar. 23, 2023

(54) Wave Powered One Way Fluid Flow Generator

(71) Applicant: Benjamin James Lemon, Waipahu, HI (US)

(72) Inventor: Benjamin James Lemon, Waipahu, HI (US)

(21) Appl. No.: 17/944,575

(22) Filed: Sep. 14, 2022

Related U.S. Application Data
(60) Provisional application No. 63/245,483, filed on Sep. 17, 2021.

(51) Int. Cl. F03B 13/14; F16L 11/127; F16K 15/14

(52) U.S. Cl. CPC F03B 13/14; F16L 11/127; F16K 15/1401; F05B 2260/95; F05B 2220/706

(57) ABSTRACT

A flexible pipe having one way fluidic flow valves containing a working fluid that generates one way fluid flow to power a generator. Preferably the pipe is buoyant or otherwise flexed by motion of any supporting or surrounding liquid, so that waves in the liquid flex the pipe. Preferably an added interior pumping arm is provided to increase the fluid flow from flexing.

### TECHNICAL FIELD

This application claims priority to U.S. provisional patent application 63/245,483, filed Sep. 17, 2021.

This invention relates to generating one way fluid flow from waves to power a generator and for other purposes.

### BACKGROUND ART

Many different types of wave power designs have been brought forward over the years. These designs have needed to increase the size, complexity or taken energy from a small portion of the ocean. Each of these approaches has diminished cost-to-power efficiency. Where increasing in size has overcome the breakage of the generators, it significantly increases the cost of installation. Strengthening the generators does allow them to last longer in the ocean, but keeps them from being cost effective. Increasing the complexity has added many different breakable parts requiring repairs. Where repairs in the ocean are costly and dangerous, this solution provides other issues. Either of these ways has made the generation of the power expensive or prone to breakage.

The third option is to take energy from a single point in the ocean, where a float moves up and down a vertical shaft with tides or waves. This does decrease the cost, but it also decreases the returns, as only a fraction of the energy can be collected in comparison to larger wave generators.

One way fluidic valves, that is, valves that allow fluid to flow in a preferred flow direction (which includes valves called “Tesla valves”), are known, but usually are made of rigid materials and are used only in static situations, that is, used with stationary, rigid, non-flexible pipes.

U.S. Pat. No. 1,329,559 to Tesla, incorporated herein by reference, discloses the original Tesla valve, that is, a passive check valve having a fixed geometry that allows a fluid to flow preferentially in one direction, without moving parts.

U.S. patent Ser. No. 10/245,586 B2 to Gilbert, incorporated herein by reference, discloses a fluidic check device.

U.S. Pat. No. 9,903,536 B2 to Lin, incorporated herein by reference, discloses a fluid diode without moving mechanical parts or deformable structures, designed using topology optimization, FIG. 15 of which briefly mentions use with waves, without any disclosure of details.

German patent 29917548 U1 to Gunter, incorporated herein by reference, specifically discloses that vibration of the structure causes fluid flow.

U.S. Pat. No. 8,650,877 to Gustafson, incorporated herein by reference, discloses a fluid, caused by heat to move in one direction by a Tesla valve, that generates electricity.

### DISCLOSURE OF INVENTION

A flexible or articulated (jointed) pipe (hereinafter collectively referred to as a flexible pipe), having an inflow end and an outflow end containing one way fluidic valves configured for substantially one way fluid flow towards the outflow end of the pipe, is filled with a working fluid and surrounded or supported (hereinafter collectively referred to as supported) by a liquid.

The one way fluidic valves can be integrally formed with the flexible pipe, including (without limitation) some or all of the one way fluidic valves being flexibly or articulably joined together, or joined to pipe sections without fluidic valves, to form the flexible pipe.

A generator having an inlet and an outlet is connected to the pipe, with the outflow end of the pipe connected to the inlet of the generator, and the inflow end of the pipe connected to the outlet of the generator, so that the pipe and the generator form a closed loop that is sealed from the supporting liquid, so that the working fluid does not mix with the supporting liquid.

Preferably the supporting liquid is the ocean or other body of liquid having undulating waves. The undulation of the supporting waves causes the pipe to flex, causing the working fluid to flow inside the pipe. However, because the pipe includes one way fluidic valves, the working fluid flows in only one direction, towards the outflow end of the pipe and into the inlet of the generator to generate electricity. The working fluid then exits from the outlet of the generator and returns into the inflow end of the pipe.

Preferably the working fluid is fresh water, to avoid corrosion of the generator.

Preferably, the one way fluidic valves in this single loop pipe are Tesla valves, optimally modified Tesla valves as disclosed below, to force water down the length of the pipe in one direction, with at least one valve having a pumping arm to act as a pump when the pipe is flexed by the waves. Although the pumping arm pumps the working fluid both in and out, because the valve is a fluidic one way valve, the pumping action results in the working fluid being pumped in the desired direction.

Instead of a generator, a reverse osmosis desalinator having an osmotic membrane, an inlet and an outlet, can be connected to the pipe, with the inflow end of the pipe in fluid communication with a source of saline water, or other source of water to be desalinated or purified, the outflow end of the pipe connected to the inlet of the desalinator, and the outlet of the desalinator connected to a collector for desalinated water. In this embodiment, the pipe and the desalinater do not form a closed loop. With the appropriate dimensions and configurations of the pipe, type of osmotic membrane, and strength of one way fluidic valves, the pipe can generate sufficient pressure to drive reverse osmosis in the desalinator. For example, although a pressurized pipe having a certain amount of hydrostatic pressure, or “head”, may be necessary to drive reverse osmosis through an osmotic membrane, that necessary hydrostatic pressure may be achievable using a shorter flexible pipe with one way fluidic valves according to the present invention, where waves or other forces flex the pipe, thus reducing materials and necessary energy for pressurization.

Other features and advantages of the present invention will be apparent from the following detailed description of the presently preferred best mode for carrying out the invention and the accompanying drawings.

### BRIEF DESCRIPTION OF DRAWINGS

FIG. 1 is a top plan view showing the interior structure of the original Tesla valve.

FIG. 2 is a side view of the Tesla valve of FIG. 1.

FIG. 3 is a schematic view of the interior structure of a modified Tesla valve according to the present invention.

FIG. 4 is a side cutaway view of a pipe according to the structure of the present invention, supported and flexed by waves.

FIG. 5 is a perspective view of a pipe according to the present invention, connected at an outflow end to the inlet of a generator, and connected at an inflow end to the outlet of a generator, forming a closed loop.

FIG. 6 is a side cutaway view of the interior structure of the modified Tesla valve of the present invention, where the pipe is not flexed.

FIG. 7 is a side cutaway view of the interior structure of the modified Tesla valve of FIG. 6, where the pipe has been flexed, showing the movement of the pumping arm.

### BEST MODES FOR CARRYING OUT INVENTION

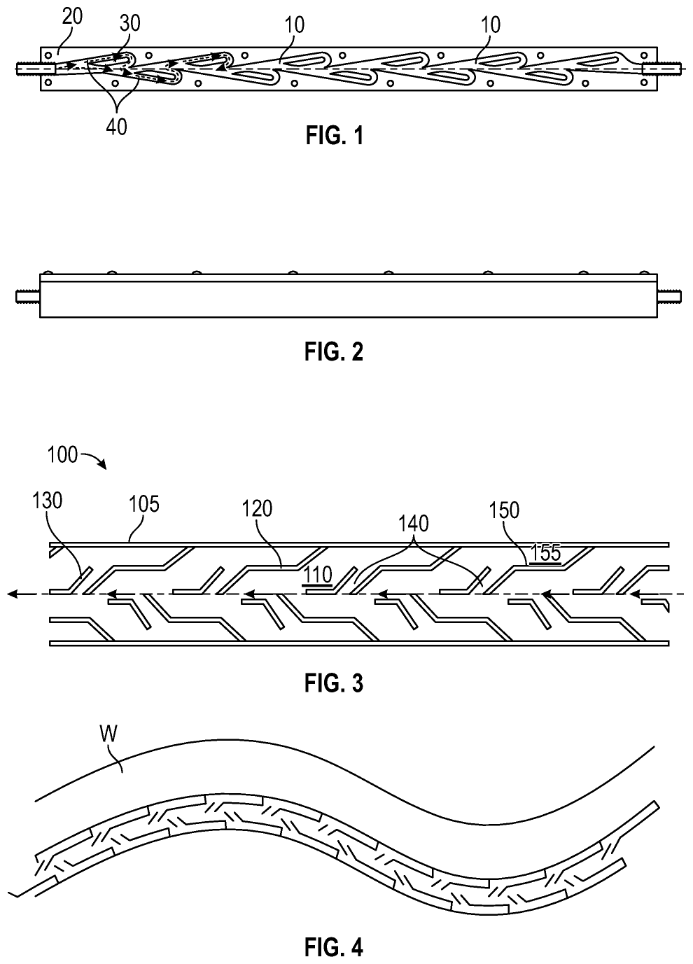

Referring to FIGS. 1 and 2, shown are a top plan view showing the interior structure of the original Tesla valve, taken from U.S. Pat. No. 1,329,559, and a side view of the original Tesla valve of FIG. 1, also taken from U.S. Pat. No. 1,329,559.

FIGS. 1 and 2 show that much of the interior of the original Tesla valve is occupied by bulk material that defines the channels or conduits (hereinafter collectively referred to as channels) 10 through which the working fluid flows. The interior of the valve that is occupied by the bulk material includes exterior material 20 that is radially outward from the channels 10, and islanded material 30 that is surrounded by the channels 10.

As can be seen and as explained in U.S. Pat. No. 1,329,559, lines 51 to 62, the interior of the channels 10 is provided with enlargements, recesses, projections, baffles or buckets (hereinafter collectively referred to as baffles) that define deflecting tributaries 40 with entrances that face backwards against the preferred direction of flow. Some of any fluid flowing from left to right, which is opposite the preferred direction of flow, flows into the openings of the deflecting tributaries 40 and is deflected by the baffles to be reversed in direction of flow, and then deflected again to reverse again, as shown by the arrows on the left side of FIG. 1, but fluid flowing from right to left, which is the preferred direction of flow, is impeded very little by the baffles.

The presently preferred best modes for carrying out the present invention are illustrated by way of example in FIGS. 3 to 7.

Referring to FIG. 3, shown is a schematic view of the interior structure of a series of one way fluidic valves, suitable for use with the present invention, specifically, a series of modified Tesla valves according to the present invention, each of which comprises a pipe 100 having walls 105. As can be seen, channels 110 are provided with baffles in the shape of walls or partitions, instead of by bulk material. Analogously to FIGS. 1 and 2, the baffles define channels 110, including exterior baffles 120 extending radially outward from channels 110 to the walls 105 of the pipe 100, and islanded baffles 130 that are surrounded by the channels 110, to form deflecting tributaries 140. This use of walls or partitions reduces the distance between baffles and enlarges the entrances to the deflecting tributaries 140 and thereby increases the resistance created to fluids flowing from left to right, which is opposite the preferred direction of flow.

The exterior baffles 120 have portions that are parallel to the walls 105 that form a pumping arm 150, and portions that extend towards or join the walls 105, to define a pump cavity 155. Unlike conventional Tesla valves, the wall 105 of the modified Tesla valve of the present invention is preferably made of flexible material, or is jointed, so that when the wall 105 of the modified Tesla valve is flexed in a first direction, the wall 105 moves to narrow the pump cavity 155 (against the pumping arm 150), forcing fluid out of the pump cavity 155, and when the wall 105 of the modified Tesla valve is flexed in the opposite direction, the wall 105 moves to widen the pump cavity 155 (away from the pumping arm 150), sucking fluid into the pump cavity 155. However, because of the one way fluidic valves, the result is pumping in the preferred direction of flow. A pumping arm includes other structures that cause pumping when a pipe having one way fluidic valves is flexed.

Preferably, the islanded baffles 130 are thicker or more rigid than the walls 105 of the pipe. When the pipe 100 is lifted by a wave, portions of the walls 105 of the pipe 100 flex radially inwards, decreasing the dimensions of the interior space of the pipe and pumping water out, because the exterior baffle 120 (part of which is the pumping arm 150) preferably is harder or more rigid than the wall 105 of the pipe 100. When the flex of the pipe 100 reverses after the wave passes, the pumping arm 150 opens up, pulling water into the pipe, as shown in FIGS. 6 and 7, and as discussed below.

Tesla valves are conventionally made from inflexible material, with bulk material to form baffles, thus wasting material. The modified Tesla valve of the present invention shortens the distance between baffles and therefore shortens the length of the valve, thus reducing material requirements, and the flexible walls 105 with the exterior baffles 120 preferably add pumping arms 150, so that the modified Tesla valve also functions as a pump, when the pipe is undulated by waves in the supporting liquid. Preferably, the supporting liquid is water having waves.

Referring to FIG. 4, shown is a side cutaway view of a flexible pipe 100 according to the structure of the present invention, supported and flexed by waves W.

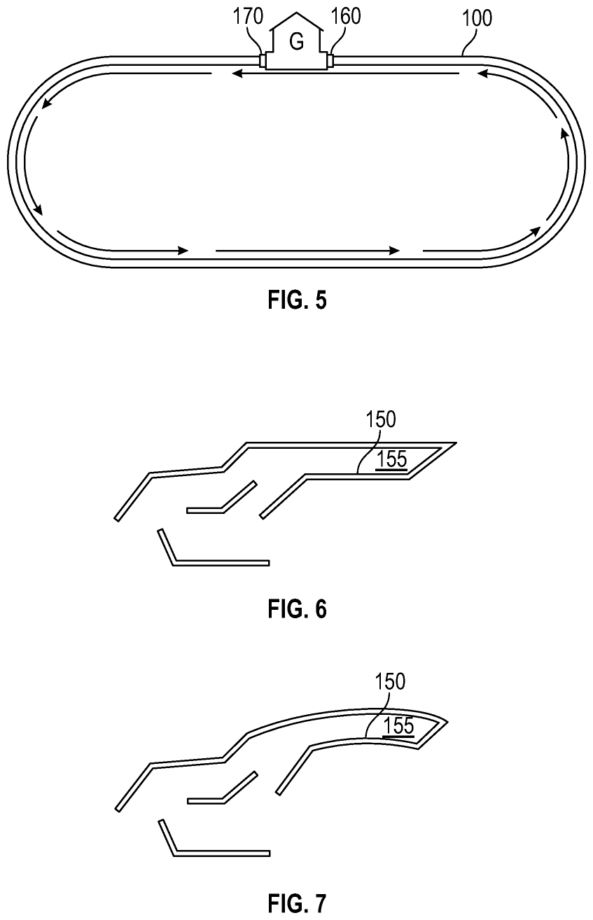

Referring to FIG. 5, shown is a perspective view of a pipe 100 according to the present invention, connected at an outflow end 160 to the inlet of a generator G, and connected at an inflow end 170 to the outlet of a generator, forming a closed loop. Any conventional generator can be used that can generate electricity from the flow of the working fluid created in the pipe 100 by the modified Tesla valves of this invention.

Preferably, the pipe 100 comprises a plurality of contiguous connected one way fluidic valves. However, there may be conventional pipes interposed between one way fluidic valves.

The diameter of the loop formed by the pipe and the generator is dependent on the desired electric output, wavelength and amplitude of expected waves, and other factors. The larger the loop, the more power it can generate. Preferably, the loop has a diameter between about 3 feet (about 1 meter) and about 15 feet (about 5 meters). The diameter of the loop, the size and shape of the cross section of the pipe, the type of working fluid, and other attributes of the loop can be adjusted as necessary, depending on the range of amplitudes and wavelengths of waves expected to be encountered, and the desired pressure generated by the pipe 100 from the outflow end 160 into the inlet of the generator G.

The cross section of the pipe can be of any suitable shape, such as round, square, rectangular or oval.

The preferred materials would be rubber with steel mesh reinforcement with a coating to prevent UV damage and growth of barnacles. Ethylene tetrafluoroethylene with a UV coating and copper would seem to be the first things that come to mind.

Preferably the flexible pipe is filled with working fluid and the fluid flow is only driven by flexing of the pipe by waves and gravity. Preferably the working fluid is water.

Preferably the pipe is buoyant or otherwise flexed by motion of any surrounding liquid, so that waves in the liquid flex the pipe. For example, the pipe can float on the surface, or can be anchored so as to float below the surface.

Preferably the one way fluidic valves are modified Tesla valves having an added interior pumping arm to increase the fluid flow from flexing, as described herein.

Referring to FIG. 6, shown is a side cutaway view of the interior structure of a single modified Tesla valve of the present invention, in which the pipe 100 is not flexed.

Referring to FIG. 7, shown is a side cutaway view of the interior structure of the single modified Tesla valve of FIG. 6, where the pipe has been flexed, showing the movement of the pumping arm 150, not necessarily to scale. Because the exterior baffle 120 forming the pumping arm 150 is preferably more rigid than the wall of the pipe, the undulation of the pipe will compress the wall inward with respect to the pumping arm 150 to cause increased pressure in the pump cavity 155.

While the present invention has been disclosed in connection with the presently preferred embodiments disclosed herein, it will be obvious to those ordinarily skilled in the art that there are other embodiments that fall within the sprit and scope of the invention, as defined by the claims. For example, the pipe can be caused to flex by means other than waves in a supporting fluid, such as by pistons or motors acting on portions of the pipe, or by movement of a structure supporting the pipe. Accordingly, no limitations are to be implied or inferred as to the scope of this patent except as specifically and explicitly set forth in the claims.

### INDUSTRIAL APPLICABILITY

This invention is applicable wherever a supporting fluid has waves, or some other means is available to cause a pipe to flex, and it is desired to create a one way fluid flow in the pipe to generate electricity, desalinate water, or perform some other desired function.

What is claimed is:

1. A device for generating electricity from waves, comprising:
a flexible pipe having an inflow end and an outflow end;
one way fluidic valves positioned inside the pipe, configured for substantially one way fluid flow towards the outflow end of the pipe;
a generator having an inlet and an outlet connected to the pipe, with the outflow end of the pipe connected to the inlet of the generator, and the inflow end of the pipe connected to the outlet of the generator, whereby the pipe and the generator form a closed loop;
a working fluid filling the pipe and powering the generator when the fluid flows from the outflow end of the pipe into the inlet of the generator, and out the outlet of the generator and into the inflow end of the pipe;
whereby, when the pipe is supported by a body of liquid having waves, the waves cause the pipe to flex, whereby the one way fluidic valves send the working fluid flowing towards the outflow end and into the inlet of the generator, and then to exit from the outlet of the generator and return into the inflow end of the pipe; and
whereby the generator generates electricity.

2. A device according to claim 1, wherein the one way fluidic valves are integrally formed with the pipe.

3. A device according to claim 1, wherein the working fluid is fresh water, to avoid corrosion of the generator.

4. A device according to claim 1, wherein at least one of the one way fluidic valves is a modified Tesla valve from a flexible material, having a pumping arm;

5. A device according to claim 1, wherein the pipe has a cross section that is selected from the group consisting of round, square, rectangular, or oval.
